(19) United States
(12) Patent Application Publication
(10) Pub. No.: US 2025/0251623 A1
(43) Pub. Date: Aug. 7, 2025

(54) DISPLAY APPARATUS

(71) Applicant: Coretronic Corporation, Hsin-Chu (TW)

(72) Inventors: Hsin Huang, Hsin-Chu (TW); Jing-Yu Wu, Hsin-Chu (TW); Ping-Yen Chen, Hsin-Chu (TW); Chung-Yang Fang, Hsin-Chu (TW)

(73) Assignee: Coretronic Corporation, Hsin-Chu (TW)

(21) Appl. No.: 19/046,525

(22) Filed: Feb. 6, 2025

(30) Foreign Application Priority Data
Feb. 7, 2024 (CN) 202410172728.6

(51) Int. Cl. G02F 1/13; G02F 1/1335; G02F 1/13363; G02F 1/1337

(52) U.S. Cl. CPC G02F 1/1323; G02F 1/133531; G02F 1/13363; G02F 1/1337

(57) ABSTRACT

A display apparatus including a self-luminous display panel and a third polarizer, a second electrically-controlled viewing angle switching device, a second polarizer, a first electrically-controlled viewing angle switching device, and a first polarizer sequentially stacked on a display surface of the self-luminous display panel is provided. The first switching device includes a first liquid-crystal layer and first and second alignment layers. The first alignment layer is located between the first liquid-crystal layer and the first polarizer. A first absorption axis of the first polarizer is parallel or perpendicular to a first alignment direction of the first alignment layer. The second switching device includes a second liquid-crystal layer and third and fourth alignment layers. The fourth alignment layer is located between the second liquid-crystal layer and the third polarizer. A third absorption axis of the third polarizer is parallel or perpendicular to a fourth alignment direction of the fourth alignment layer.

### CROSS-REFERENCE TO RELATED APPLICATION

This application claims the priority benefit of China application serial no. 202410172728.6 filed on Feb. 7, 2024. The entirety of the above-mentioned patent application is hereby incorporated by reference herein and made a part of this specification.

### BACKGROUND OF THE DISCLOSURE

### Field of the Disclosure

The disclosure relates to a display apparatus, and in particular to a display apparatus having a viewing angle control function.

### Description of Related Art

Generally, in order to allow a plurality of viewers to watch a display at the same time, a display apparatus usually has a wide viewing angle display effect. However, in certain situations or occasions, such as when browsing private web pages, confidential information, or entering passwords in public, the wide viewing angle display effect makes it easy for others to peek at the screen and leak confidential information. In order to achieve privacy protection effect, a common practice is to place a light control film (LCF) in front of the display panel to filter out large-angle image light, and provide an electrically-controlled diffusion sheet at the light exit side of the light control film, so that the display apparatus may readily switch between different display modes (such as a wide viewing angle mode and a narrow viewing angle mode).

However, the installation of the light control film and the electrically-controlled diffusion sheet not only reduces the overall brightness of the display apparatus, but also significantly increases the operating power consumption thereof. In addition, such a configuration may not meet the privacy protection requirements of the display apparatus in a plurality of directions, such as electrically-controlled switching between single-sided privacy protection and dual-sided privacy protection in one dimension. Therefore, developing a display apparatus that is extremely convenient for viewing angle switching and may meet the privacy protection requirements of a plurality of products in different usage scenarios is still an important issue for relevant manufacturers.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY OF THE DISCLOSURE

An embodiment of the disclosure provides a display apparatus. The display apparatus includes a self-luminous display panel, a first electrically-controlled viewing angle switching device, a second electrically-controlled viewing angle switching device, a first polarizer, a second polarizer, and a third polarizer. The first electrically-controlled viewing angle switching device is disposed at a side of a display surface of the self-luminous display panel and includes a first liquid-crystal layer, a first alignment layer, and a second alignment layer. The first liquid-crystal layer is disposed between the first alignment layer and the second alignment layer. The second electrically-controlled viewing angle switching device is disposed between the first electrically-controlled viewing angle switching device and the self-luminous display panel, and includes a second liquid-crystal layer, a third alignment layer, and a fourth alignment layer. The second liquid-crystal layer is disposed between the third alignment layer and the fourth alignment layer. The first polarizer is disposed at a side of the first electrically-controlled viewing angle switching device facing away from the second electrically-controlled viewing angle switching device, and has a first absorption axis. The first alignment layer is located between the first liquid-crystal layer and the first polarizer, and an axial direction of the first absorption axis is parallel or perpendicular to a first alignment direction of the first alignment layer. The second polarizer is disposed between the first electrically-controlled viewing angle switching device and the second electrically-controlled viewing angle switching device, and has a second absorption axis. The third polarizer is disposed between the self-luminous display panel and the second electrically-controlled viewing angle switching device and has a third absorption axis. The fourth alignment layer is located between the second liquid-crystal layer and the third polarizer, and an axial direction of the third absorption axis is parallel or perpendicular to a fourth alignment direction of the fourth alignment layer.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

FIG. 1 is a schematic cross-sectional view of a display apparatus according to the first embodiment of the disclosure.

FIG. 2A and FIG. 2B are schematic views of the arrangement relationship between the alignment direction of the alignment layer, the axial direction of the absorption axis of the polarizer, and the axial direction of the slow axis of the half-wave plate of FIG. 1.

FIG. 3 is a graph of brightness versus viewing angle of the display apparatus of FIG. 1 operated in different display modes.

FIG. 4 is a schematic cross-sectional view of a display apparatus according to the second embodiment of the disclosure.

FIG. 5 is a schematic view of the arrangement relationship between the alignment direction of the alignment layer and the axial direction of the absorption axis of the polarizer of FIG. 4.

FIG. 6 is a graph of brightness versus viewing angle of the display apparatus of FIG. 4 operated in different display modes.

FIG. 7 is a schematic cross-sectional view of a display apparatus according to the third embodiment of the disclosure.

FIG. 8 is a schematic view of the arrangement relationship between the alignment direction of the alignment layer and the axial direction of the absorption axis of the polarizer of FIG. 7.

FIG. 9 is a graph of brightness versus viewing angle of the display apparatus of FIG. 7 operated in different display modes.

FIG. 10 is a schematic cross-sectional view of a display apparatus according to the fourth embodiment of the disclosure.

FIG. 11A and FIG. 11B are schematic views of the arrangement relationship between the alignment direction of the alignment layer and the axial direction of the absorption axis of the polarizer of FIG. 10.

FIG. 12 is a schematic cross-sectional view of a display apparatus according to the fifth embodiment of the disclosure.

FIG. 13A and FIG. 13B are schematic views of the arrangement relationship between the alignment direction of the alignment layer and the axial direction of the absorption axis of the polarizer of FIG. 12.

FIG. 14 is a graph of brightness versus viewing angle of the display apparatus of FIG. 12 operated in different display modes.

FIG. 15 is a schematic cross-sectional view of a display apparatus according to the sixth embodiment of the disclosure.

FIG. 16A and FIG. 16B are schematic views of the arrangement relationship between the alignment direction of the alignment layer and the axial direction of the absorption axis of the polarizer of FIG. 15.

FIG. 17 is a graph of brightness versus viewing angle of the display apparatus of FIG. 15 operated in different display modes.

FIG. 18 is a schematic cross-sectional view of a display apparatus according to the seventh embodiment of the disclosure.

FIG. 19A and FIG. 19B are schematic views of the arrangement relationship between the alignment direction of the alignment layer, the axial direction of the absorption axis of the polarizer, and the axial direction of the optical axis of the quarter-wave plate of FIG. 18.

FIG. 20 is a schematic cross-sectional view of a display apparatus according to the eighth embodiment of the disclosure.

FIG. 21A and FIG. 21B are schematic views of the arrangement relationship between the alignment direction of the alignment layer, the axial direction of the absorption axis of the polarizer, and the axial direction of the optical axis of the quarter-wave plate of FIG. 20.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The disclosure provides a display apparatus having better privacy protection effect and may meet the privacy protection requirements of a plurality of product applications in different usage scenarios.

Other objects and advantages of the disclosure may be further understood from the technical characteristics disclosed in the disclosure.

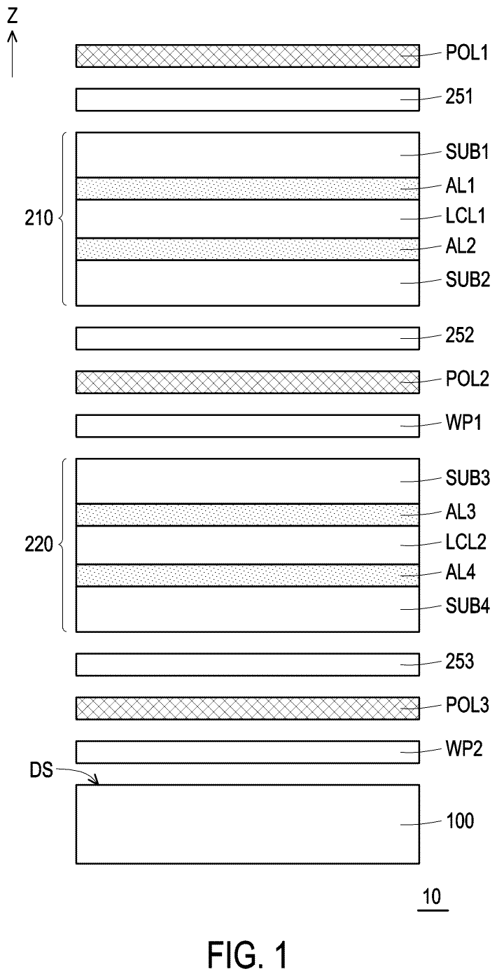

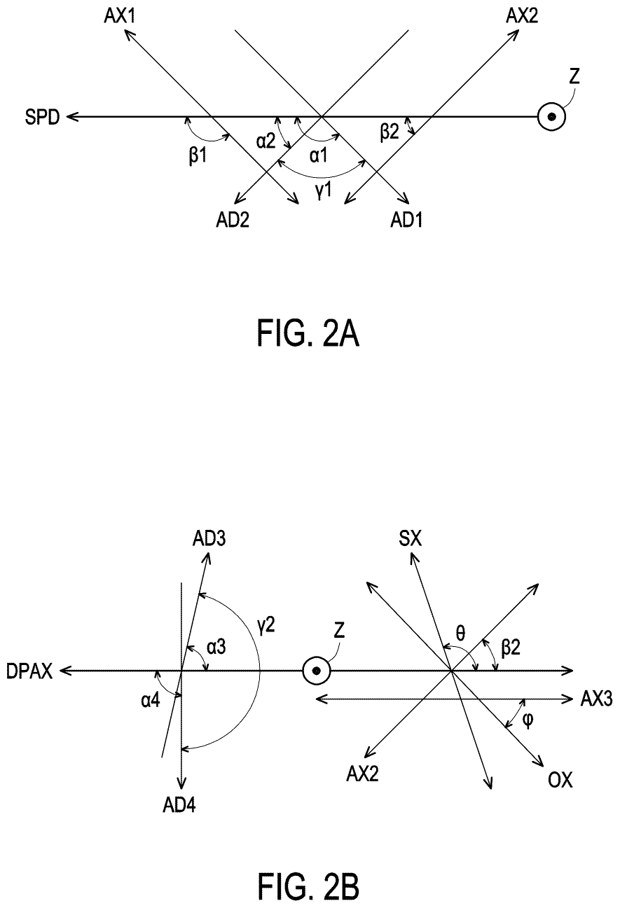

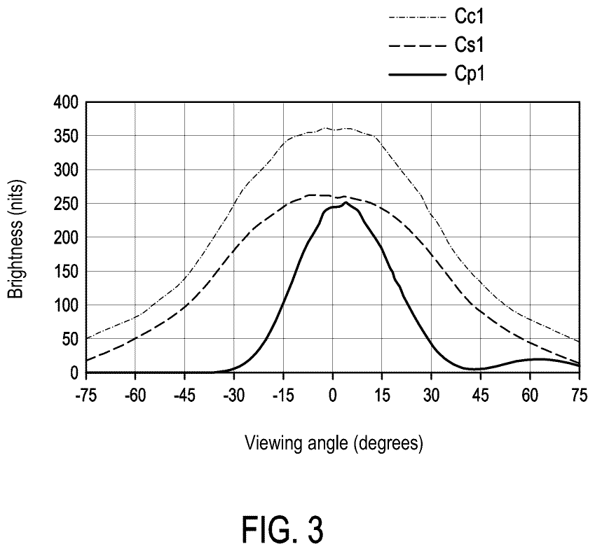

FIG. 1 is a schematic cross-sectional view of a display apparatus according to the first embodiment of the disclosure. FIG. 2A and FIG. 2B are schematic views of the arrangement relationship between the alignment direction of the alignment layer, the axial direction of the absorption axis of the polarizer, and the axial direction of the slow axis of the half-wave plate of FIG. 1. FIG. 3 is a graph of brightness versus viewing angle of the display apparatus of FIG. 1 operated in different display modes. It should be noted that the relationship of the directions in FIG. 2A and FIG. 2B is, for example, the relationship of the directions in each direction in the top view of the display apparatus 10. The relationship diagram of the directions in the disclosure is analogous and is not described again.

Please refer to FIG. 1. A display apparatus 10 includes a self-luminous display panel 100, a first electrically-controlled viewing angle switching device 210, a second electrically-controlled viewing angle switching device 220, a first polarizer POL1, a second polarizer POL2, and a third polarizer POL3. The first electrically-controlled viewing angle switching device 210 is disposed at a side of a display surface DS of the self-luminous display panel 100. The second electrically-controlled viewing angle switching device 220 is disposed between the first electrically-controlled viewing angle switching device 210 and the self-luminous display panel 100. The first polarizer POL1 is disposed at a side of the first electrically-controlled viewing angle switching device 210 facing away from the second electrically-controlled viewing angle switching device 220. The second polarizer POL2 is disposed between the first electrically-controlled viewing angle switching device 210 and the second electrically-controlled viewing angle switching device 220. The third polarizer POL3 is disposed between the self-luminous display panel 100 and the second electrically-controlled viewing angle switching device 220.

More specifically, on the display surface DS of the self-luminous display panel 100 and along a direction Z, the third polarizer POL3, the second electrically-controlled viewing angle switching device 220, the second polarizer POL2, the first electrically-controlled viewing angle switching device 210, and the first polarizer POL1 are sequentially stacked. The direction Z is, for example, perpendicular to the display surface DS.

The self-luminous display panel 100 is, for example, an organic light-emitting diode (OLED) display panel, a micro-LED display panel, or a mini-LED display panel, but the disclosure is not limited thereto.

The first electrically-controlled viewing angle switching device 210 includes a first substrate SUB1, a second substrate SUB2, a first liquid-crystal layer LCL1, a first alignment layer AL1, and a second alignment layer AL2. The first alignment layer AL1 is disposed on the first substrate SUB1 and located between the first liquid-crystal layer LCL1 and the first polarizer POL1 (for example, located between the first liquid-crystal layer LCL1 and the first substrate SUB1). The second alignment layer AL2 is disposed on the second substrate SUB2 and located between the first liquid-crystal layer LCL1 and the second polarizer POL2 (for example, located between the first liquid-crystal layer LCL1 and the second substrate SUB2). The first liquid-crystal layer LCL1 is disposed between the first alignment layer AL1 and the second alignment layer AL2.

The second electrically-controlled viewing angle switching device 220 includes a third substrate SUB3, a fourth substrate SUB4, a second liquid-crystal layer LCL2, a third alignment layer AL3, and a fourth alignment layer ALA. The third alignment layer AL3 is disposed on the third substrate SUB3 and located between the second liquid-crystal layer LCL2 and the second polarizer POL2 (for example, located between the second liquid-crystal layer LCL2 and the third substrate SUB3). The fourth alignment layer AL4 is disposed on the fourth substrate SUB4 and located between the second liquid-crystal layer LCL2 and the third polarizer POL3 (for example, located between the second liquid-crystal layer LCL2 and the fourth substrate SUB4). The second liquid-crystal layer LCL2 is disposed between the third alignment layer AL3 and the fourth alignment layer AL4.

The material of substrates of the electrically-controlled viewing angle switching device may include glass, triacetate cellulose (TAC), cyclo-olefin polymer (COP), polycarbonate (PC), polymethyl methacrylate (PMMA), polyimide (PI), other suitable polymers, or plates having phase retardation (such as stretch compensation films).

The two alignment layers of each electrically-controlled viewing angle switching device are configured to determine the alignment direction (alignment state) of the liquid-crystal layer in a natural state (e.g., not affected by an electric field). In order to drive the liquid-crystal layer, each electrically-controlled viewing angle switching device may also include two electrode layers (not shown) respectively disposed at two opposite sides of the liquid-crystal layer. When the two electrode layers are enabled to have a potential difference, a plurality of liquid-crystal molecules (not shown) of the liquid-crystal layer are deflected by the electric field formed between the two electrode layers. Specifically, in the disclosure, the liquid-crystal layer of the electrically-controlled viewing angle switching device may be driven in twisted-nematic (TN) mode or electrically-controlled birefringence (ECB) mode.

Please refer to FIG. 1 to FIG. 2B at the same time. In the embodiment, the first electrically-controlled viewing angle switching device 210 may have a single-sided privacy protection direction SPD perpendicular to the direction Z, and the second electrically-controlled viewing angle switching device 220 may have a double-sided privacy protection axial direction DPAX perpendicular to the direction Z. Specifically, the double-sided privacy protection axial direction DPAX includes the 90-degree direction and the −90-degree direction that are in the same dimension (for example, in the horizontal dimension (horizontal viewing angle) in FIG. 2B, the front viewing angle direction is 0 degrees, the front viewing angle direction is, for example, the direction Z, and the viewing angle of the horizontal dimension is 90 degrees to −90 degrees) and opposite to each other. In particular, the 90-degree direction is, for example, the direction toward the right side in FIG. 2B, and the −90-degree direction is, for example, the direction toward the left side in FIG. 2B.

In the embodiment, the single-sided privacy protection direction SPD of the first electrically-controlled viewing angle switching device 210 may be parallel to the −90-degree direction of the double-sided privacy protection axial direction DPAX of the second electrically-controlled viewing angle switching device 220, but the disclosure is not limited thereto. It should be mentioned first that, the first electrically-controlled viewing angle switching device 210 enables the display apparatus 10 to have a privacy protection effect within a one-side viewing angle range along the single-sided privacy protection direction SPD, and the second electrically-controlled viewing angle switching device 220 enables the display apparatus 10 to have a privacy protection effect within the viewing angle range of two sides along the double-sided privacy protection axial direction DPAX.

For example, in the embodiment, a first alignment direction AD1 of the first alignment layer AL1 of the first electrically-controlled viewing angle switching device 210 may be optionally perpendicular to a second alignment direction AD2 of the second alignment layer AL2. That is, the first liquid-crystal layer LCL1 of the first electrically-controlled viewing angle switching device 210 of the embodiment is driven in the twisted nematic (TN) mode, and an included angle γ1 between the first alignment direction AD1 and the second alignment direction AD2 is 90 degrees (for example, the included angle between the first alignment direction AD1 and the second alignment direction AD2 when turning clockwise, as shown in the FIG. The included angle in the disclosure may be deduced in the same way and is not described again). In the embodiment, the included angle between the single-sided privacy protection direction SPD and each of the first alignment direction AD1 and the second alignment direction AD2 is 45 degrees or 135 degrees (in other embodiments, the included angle is 45±5 degrees or 135±5 degrees). For example, an included angle α1 between the first alignment direction AD1 and the single-sided privacy protection direction SPD may be 135 degrees, and an included angle α2 between the second alignment direction AD2 and the single-sided privacy protection direction SPD may be 45 degrees.

An included angle γ2 between the third alignment direction AD3 of the third alignment layer AL3 and the fourth alignment direction AD4 of the fourth alignment layer ALA of the second electrically-controlled viewing angle switching device 220 may be greater than or equal to 150 degrees (not greater than 180 degrees). In the embodiment, the included angle between the double-sided privacy protection axial direction DPAX and each of the third alignment direction AD3 and the fourth alignment direction AD4 is greater than or equal to 75 degrees and less than or equal to 105 degrees (between 75 degrees and 105 degrees). For example, an included angle α3 between the third alignment direction AD3 and the 90-degree direction of the double-sided privacy protection axial direction DPAX may be 85 degrees, and an included angle α4 between the fourth alignment direction AD4 and the −90-degree direction of the double-sided privacy protection axial directions DPAX may be 90 degrees.

The maximum phase retardation of the first liquid-crystal layer LCL1 may be greater than 0.8 μm, preferably in the range of 1.04 μm to 1.1 μm. The maximum phase retardation of the second liquid-crystal layer LCL2 may preferably be greater than 0.5 μm and less than 1.2 μm. In the embodiment, the maximum phase retardation of the first liquid-crystal layer LCL1 is, for example, 1.08 μm, and the maximum phase retardation of the second liquid-crystal layer LCL2 is, for example, 0.933 μm.

The maximum phase retardation is, for example, the product of the difference between the ordinary ray refractive index and the extraordinary ray refractive index of the liquid-crystal molecules (not shown) of the liquid-crystal layer and the thickness of the liquid-crystal layer. In particular, compared with the liquid-crystal layer used in a general liquid-crystal display panel, the liquid-crystal layer of the electrically-controlled viewing angle switching device of the disclosure has a significantly greater maximum phase retardation.

Moreover, the first polarizer POL1, the second polarizer POL2, and the third polarizer POL3 respectively have a first absorption axis AX1, a second absorption axis AX2, and a third absorption axis AX3. In the embodiment, the axial direction of the first absorption axis AX1 of the first polarizer POL1 may be parallel to the first alignment direction AD1 of the first alignment layer AL1, and the axial direction of the third absorption axis AX3 of the third polarizer POL3 may be perpendicular to the fourth alignment direction AD4 of the fourth alignment layer AL4, but the disclosure is not limited thereto. In other embodiments, the axial direction of the first absorption axis AX1 may be perpendicular to the first alignment direction AD1, and the axial direction of the third absorption axis AX3 may be parallel to the fourth alignment direction AD4.

In the embodiment, the axial direction of the second absorption axis AX2 of the second polarizer POL2 may be perpendicular to the axial direction of the first absorption axis AX1 of the first polarizer POL1. The included angle between the single-sided privacy protection direction SPD and each of the first absorption axis AX1 and the second absorption axis AX2 is 45 degrees or 135 degrees (in other embodiments, the included angle is 45±5 degrees or 135±degrees). For example, an included angle β1 between the first absorption axis AX1 and the single-sided privacy protection direction SPD may be 135 degrees, and an included angle β2 between the second absorption axis AX2 and the single-sided privacy protection direction SPD (or the double-sided privacy protection axial direction DPAX) may be 45 degrees.

In the embodiment, the third absorption axis AX3 of the third polarizer POL3 may be parallel to the double-sided privacy protection axial direction DPAX, but the disclosure is not limited thereto. In other embodiments, the included angle between the third absorption axis AX3 and the double-sided privacy protection axial direction DPAX may be greater than or equal to 0 degrees and less than or equal to 15 degrees, or greater than or equal to 90 degrees and less than 105 degrees.

The display apparatus 10 may also optionally include a half-wave plate WP1 and a quarter-wave plate WP2. The half-wave plate WP1 is disposed between the first electrically-controlled viewing angle switching device 210 and the second electrically-controlled viewing angle switching device 220. The quarter-wave plate WP2 is disposed between the self-luminous display panel 100 and the third polarizer POL3, and an included angle σ between the third absorption axis AX3 and an optical axis OX of the quarter-wave plate WP2 is 45 degrees.

It should be noted that an included angle η between a slow axis SX of the half-wave plate WP1 and the double-sided privacy protection axial direction DPAX may be (α3+β2+90 degrees)/2 or (α3+β2+90 degrees)/2+90 degrees. For example, in the embodiment, the included angle α3 between the third alignment direction AD3 and the 90-degree direction of the double-sided privacy protection axial direction DPAX and the included angle β2 between the second absorption axis AX2 and the 90-degree direction of the double-sided privacy protection axial direction DPAX are respectively 85 degrees and 45 degrees. Therefore, the included angle η is 110 degrees, but the disclosure is not limited thereto. In another embodiment, the included angle η may be 200 degrees.

In the embodiment, the display apparatus 10 may further include a compensation film 251, a compensation film 252, and a compensation film 253. The compensation film 251 is disposed between the first polarizer POL1 and the first electrically-controlled viewing angle switching device 210. The compensation film 252 is disposed between the second polarizer POL2 and the second alignment layer AL2. The compensation film 253 is disposed between the third polarizer POL3 and the second electrically-controlled viewing angle switching device 220. However, the disclosure is not limited thereto. In other embodiments, the compensation film located between the two electrically-controlled viewing angle switching devices may also be disposed between the second polarizer POL2 and the third alignment layer AL3, or a compensation film is not provided between the two electrically-controlled viewing angle switching devices.

The out-of-plane phase retardations (Rth) of the compensation film 251, the compensation film 252, and the compensation film 253 may be in the range of −50 nm to −300 nm or in the range of 100 nm to 500 nm. The out-of-plane phase retardation here may be defined by the following relationship: Rth=[(nx+ny)/2−nz] *d, wherein nx and ny are respectively the two refractive indexes of the compensation film along two directions parallel to the film surface and perpendicular to each other, nz is the refractive index of the compensation film along the direction perpendicular to the film surface, and d is the film thickness of the compensation film.

For example, in the embodiment, the sum of the out-of-plane phase retardation of the compensation film 251 and the compensation film 252 located between the first polarizer POL1 and the second polarizer POL2 may be −200 nm, and the out-of-plane phase retardation of the compensation film 253 located between the fourth alignment layer AL4 and the third polarizer POL3 may be 280 nm, but the disclosure is not limited thereto.

Please refer to FIG. 1 and FIG. 3. As a comparison, a curve Cc1 is a distribution curve of brightness versus viewing angle of the self-luminous display panel 100. A curve Cs1 is a distribution curve of brightness versus viewing angle when the display apparatus 10 is operated in the sharing mode. A curve Cp1 is a distribution curve of brightness versus viewing angle when the display apparatus 10 is operated in the privacy protection mode.

In the embodiment, when the display apparatus 10 is operated in the sharing mode, neither the first electrically-controlled viewing angle switching device 210 nor the second electrically-controlled viewing angle switching device 220 is enabled. That is, the potential difference between the first alignment layer AL1 and the second alignment layer AL2 and the potential difference between the third alignment layer AL3 and the fourth alignment layer AL4 are both 0 V (or close to 0 V). On the contrary, when the first electrically-controlled viewing angle switching device 210 and the second electrically-controlled viewing angle switching device 220 are enabled, the display apparatus 10 is operated in the privacy protection mode. For example, when the potential difference between the first alignment layer AL1 and the second alignment layer AL2 is 2.9 V and the potential difference between the third alignment layer AL3 and the fourth alignment layer ALA is 4.5 V, and the distribution curve of brightness versus viewing angle of the display apparatus 10 is the curve Cp1 of FIG. 3.

It should be noted that the positive portion of the viewing angle range in FIG. 3 corresponds to the horizontal viewing angle range of the 90-degree direction side of the double-sided privacy protection axial direction DPAX in FIG. 2B, and the negative portion of the viewing angle range in FIG. 3 corresponds to the horizontal viewing angle range of the −90-degree direction side of the double-sided privacy protection axial direction DPAX in FIG. 2B, and the front viewing angle direction (for example, the direction Z) is 0 degrees.

As may be seen from FIG. 3, when the display apparatus 10 is operated in the privacy protection mode, the privacy protection effect thereof of the left side viewing angle range is significantly better than the privacy protection effect thereof of the right-side viewing angle range. This is caused by the superposition effect of the light filtering effects of the first electrically-controlled viewing angle switching device 210 and the second electrically-controlled viewing angle switching device 220. In the embodiment, the first electrically-controlled viewing angle switching device 210 has the single-sided privacy protection direction SPD facing the left side in FIG. 2A, and the second electrically-controlled viewing angle switching device 220 has the double-sided privacy protection axial direction DPAX facing the two sides in FIG. 2B. Therefore, in the display apparatus 10 in FIG. 2B, the light filtering capability of the left side viewing angle range is better than the light filtering capability of the right-side viewing angle range.

Based on the above light filtering characteristics, the display apparatus 10 of the embodiment is suitable for application in a vehicle-mounted personal display. For example, taking a left-hand drive vehicle as an example, the driver's seat of the vehicle may be arranged within the negative viewing angle range of the display apparatus 10. When the vehicle is traveling at night, the display apparatus 10 may be switched to the privacy protection mode. At this time, the light filtering effect of the first electrically-controlled viewing angle switching device 210 and the second electrically-controlled viewing angle switching device 220 of the driver's side may prevent the driver from being disturbed by the display light emitted by the display apparatus 10. In addition, the light filtering effect of the second electrically-controlled viewing angle switching device 220 within the positive viewing angle range may further reduce the brightness of the reflection on the passenger seat (front passenger seat) window. Accordingly, when the passenger in the passenger seat uses the display apparatus 10, it may also be ensured that the driver is not affected by the display light, thereby improving the safety of the vehicle driving at night.

Other embodiments are enumerated below to describe the disclosure in detail, wherein the same members are marked with the same reference numerals, and descriptions of the same technical content are omitted. Please refer to the previous embodiments for the omitted portions, which are not described again below.

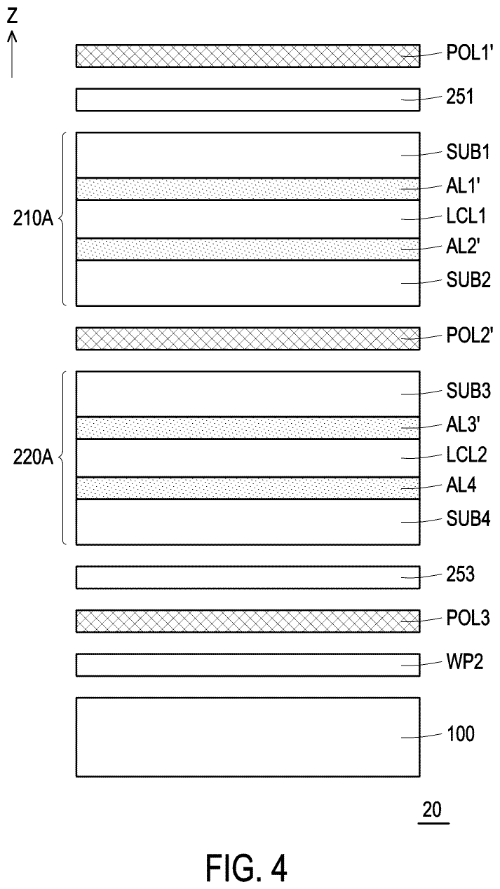

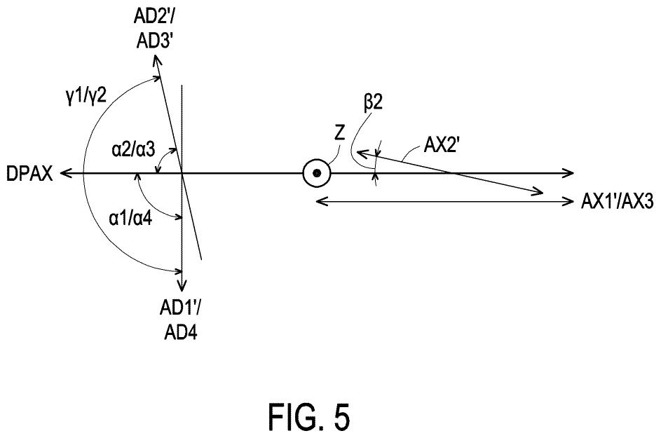

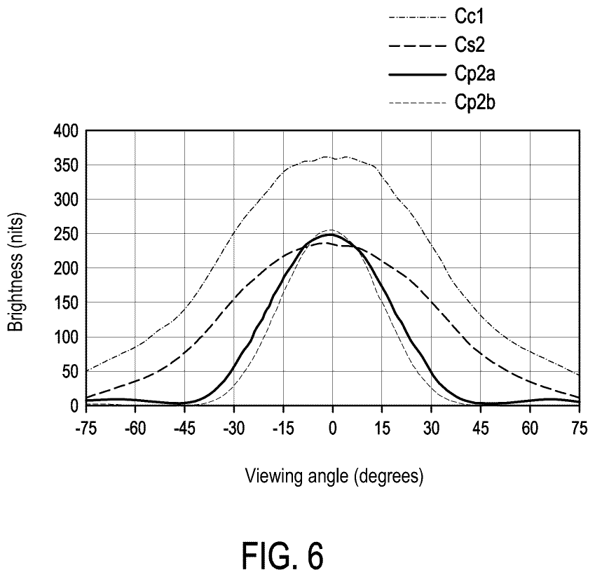

FIG. 4 is a schematic cross-sectional view of a display apparatus according to the second embodiment of the disclosure. FIG. 5 is a schematic view of the arrangement relationship between the alignment direction of the alignment layer and the axial direction of the absorption axis of the polarizer of FIG. 4. FIG. 6 is a graph of brightness versus viewing angle of the display apparatus of FIG. 4 operated in different display modes.

Please refer to FIG. 4 and FIG. 5. The main difference between a display apparatus 20 of the embodiment and the display apparatus 10 of FIG. 1 is the designs of the two electrically-controlled viewing angle switching devices are different. Specifically, in the embodiment, both a first electrically-controlled viewing angle switching device 210A and a second electrically-controlled viewing angle switching device 220A have the same double-sided privacy protection axial direction DPAX. That is, the two electrically-controlled viewing angle switching devices may both enable the display apparatus 20 to have a privacy protection effect within the viewing angle range of two sides along the double-sided privacy protection axial direction DPAX.

In the embodiment, the included angle γ1 between a first alignment direction AD1′ of a first alignment layer AL1′ and a second alignment direction AD2′ of a second alignment layer AL2′ of the first electrically-controlled viewing angle switching device 210A and the included angle γ2 between the fourth alignment direction AD4 of the fourth alignment layer AL4 and a third alignment direction AD3′ of a third alignment layer AL3′ of the second electrically-controlled viewing angle switching device 220A are both greater than or equal to 150 degrees (not greater than 180 degrees). The included angle between the double-sided privacy protection axial direction DPAX and each of the first alignment direction AD1′, the second alignment direction AD2′, the third alignment direction AD3′, and the fourth alignment direction AD4 is greater than or equal to 75 degrees and less than or equal to 105 degrees.

For example, the included angle α1 between the first alignment direction AD1′ and the −90-degree direction of the double-sided privacy protection axial direction DPAX may be 90 degrees. The included angle α2 between the −90-degree direction of the double-sided privacy protection axial direction DPAX and the second alignment direction AD2′ may be 85 degrees. The included angle α3 between the −90-degree direction of the double-sided privacy protection axial direction DPAX and the third alignment direction AD3′ may be 85 degrees, and the included angle α4 between the fourth alignment direction AD4 and the −90-degree direction of the double-sided privacy protection axial directions DPAX may be 90 degrees. More specifically, in the embodiment, the first alignment direction AD1′ and the fourth alignment direction AD4 are parallel to each other and perpendicular to the double-sided privacy protection axial direction DPAX, and the second alignment direction AD2′ is parallel to the third alignment direction AD3′.

The maximum phase retardation of each of the first liquid-crystal layer LCL1 and the second liquid-crystal layer LCL2 may preferably be greater than 0.5 μm and less than 1.2 μm. In the embodiment, the maximum phase retardation of the first liquid-crystal layer LCL1 is, for example, 0.6 μm, and the maximum phase retardation of the second liquid-crystal layer LCL2 is, for example, 0.83 μm.

In the embodiment, the axial direction of a first absorption axis AX1′ of a first polarizer POL1′ may be perpendicular to the first alignment direction AD1′, and the axial direction of the third absorption axis AX3 of the third polarizer POL3 may be perpendicular to the fourth alignment direction AD4. The included angle β2 between the −90-degree direction of the double-sided privacy protection axial direction DPAX and a second absorption axis AX2′ of a second polarizer POL2′ is, for example, 5 degrees, but the disclosure is not limited thereto. In other embodiments, the included angle β2 may be greater than or equal to 0 degrees and less than or equal to 15 degrees (in other embodiments, the included angle β2 may be greater than or equal to 0 degrees and less than or equal to 15 degrees, or greater than or equal to 90 degrees and less than 105 degrees).

In the embodiment, the out-of-plane phase retardation of the compensation film 251 located between the first polarizer POL1′ and the second polarizer POL2′ is, for example, 280 nm, and the out-of-plane phase retardation of the compensation film 253 located between the fourth alignment layer AL4 and the third polarizer POL3 may be 280 nm, but the disclosure is not limited thereto.

It should be noted that due to the configuration relationship between the first electrically-controlled viewing angle switching device 210A and the second electrically-controlled viewing angle switching device 220A, the display apparatus 20 of the embodiment does not have the half-wave plate WP1 and the compensation film 252 as shown in FIG. 1 between the two electrically-controlled viewing angle switching devices. Since the remaining members not mentioned are all similar to the display apparatus 10 of

FIG. 1, please refer to the related paragraphs of the above embodiments for detailed description, and the remaining members are not described again here.

Please refer to FIG. 4 and FIG. 6. As a comparison, a curve Cc1 is a distribution curve of brightness versus viewing angle of the self-luminous display panel 100. A curve Cs2 is a distribution curve of brightness versus viewing angle when the display apparatus 20 is operated in the sharing mode. A curve Cp2a and a curve CP2b are distribution curves of brightness versus viewing angle when the display apparatus 20 is operated in the first privacy protection mode and the second privacy protection mode respectively.

In the embodiment, when the display apparatus 20 is operated in the sharing mode, neither the first electrically-controlled viewing angle switching device 210A nor the second electrically-controlled viewing angle switching device 220A is enabled. That is, the potential difference between the first alignment layer AL1′ and the second alignment layer AL2′ and the potential difference between the third alignment layer AL3′ and the fourth alignment layer AL4 are both 0 V. On the contrary, when at least one of the first electrically-controlled viewing angle switching device 210A and the second electrically-controlled viewing angle switching device 220A is enabled, the display apparatus 20 is operated in the privacy protection mode.

For example, when the potential difference between the first alignment layer AL1′ and the second alignment layer AL2′ is 0 V and the potential difference between the third alignment layer AL3′ and the fourth alignment layer AL4 is 2.5 V, the distribution curve of brightness versus viewing angle of the display apparatus 20 operated in the first privacy protection mode is the curve Cp2a of FIG. 6. When the potential difference between the first alignment layer AL1′ and the second alignment layer AL2′ is 2.3 V and the potential difference between the third alignment layer AL3′ and the fourth alignment layer ALA is 2.5 V, the distribution curve of brightness versus viewing angle of the display apparatus 20 operated in the second privacy protection mode is the curve Cp2b of FIG. 6.

It may be seen from FIG. 6 that the light filtering effect of the display apparatus 20 operated in the first privacy protection mode (or the second privacy protection mode) is not significantly different between the positive viewing angle range and the negative viewing angle range. It should be particularly noted that when both the first electrically-controlled viewing angle switching device 210A and the second electrically-controlled viewing angle switching device 220A are enabled (second privacy protection mode), the privacy protection effect of the display apparatus 20 (as shown by the curve Cp2b) is significantly better than the privacy protection effect when only the second electrically-controlled viewing angle switching device 220A is turned on (as shown by the curve Cp2a). That is, the display apparatus 20 of the embodiment may meet the privacy protection requirements in different usage scenarios by adjusting the number of active electrically-controlled viewing angle switching devices and the voltages thereof.

In particular, in the embodiment, a reflective polarizing layer (not shown) or a metal wire grid polarizing layer may be disposed between the second polarizer POL2′ and the second alignment layer AL2′ of FIG. 4., but the disclosure is not limited thereto. Accordingly, when the display apparatus 20 is operated in the privacy protection mode, ambient light may be reflected by the reflective polarizing layer within the privacy protection viewing angle range, thus reducing the contrast of the display image within the privacy protection viewing angle range, and thus further improving the privacy protection effect.

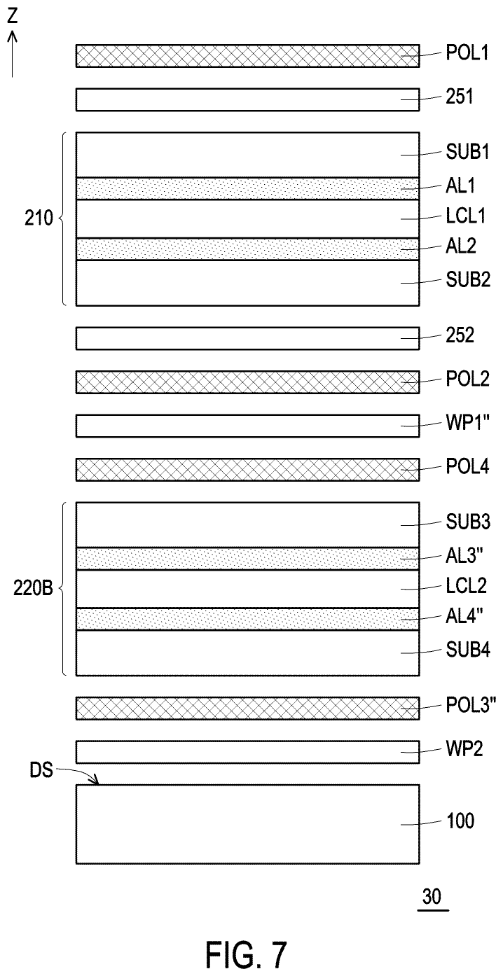

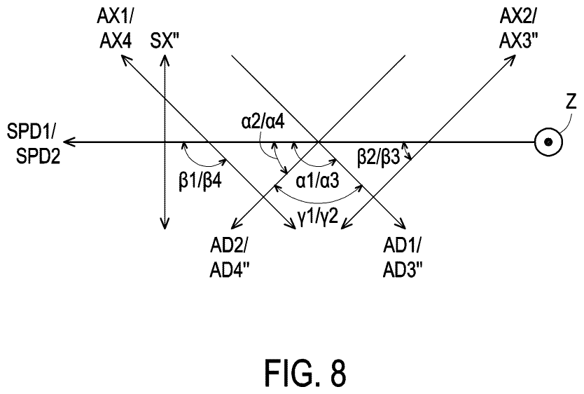

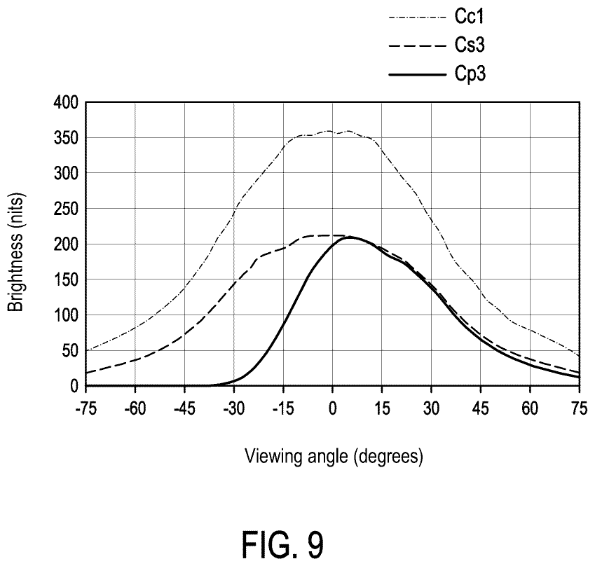

FIG. 7 is a schematic cross-sectional view of a display apparatus according to the third embodiment of the disclosure. FIG. 8 is a schematic view of the arrangement relationship between the alignment direction of the alignment layer and the axial direction of the absorption axis of the polarizer of FIG. 7. FIG. 9 is a graph of brightness versus viewing angle of the display apparatus of FIG. 7 operated in different display modes. Please refer to FIG. 7 and FIG. 8. The main difference between a display

apparatus 30 of the embodiment and the display apparatus 10 of FIG. 1 is the design of the second electrically-controlled viewing angle switching device is different. Specifically, in the embodiment, the first electrically-controlled viewing angle switching device 210A and the second electrically-controlled viewing angle switching device 220A respectively have a first single-sided privacy protection direction SPD1 and a second single-sided privacy protection direction SPD2. The first single-sided privacy protection direction SPD1 is parallel to the second single-sided privacy protection direction SPD2 and the directions thereof are the same.

In the embodiment, the included angle γ2 between a third alignment direction AD3″ of a third alignment layer AL3″ and a fourth alignment direction AD4″ of a fourth alignment layer AL4″ of the second electrically-controlled viewing angle switching device 220B is 90 degrees. That is, the third alignment direction AD3″ is perpendicular to the fourth alignment direction AD4″. The included angle between the single-sided privacy protection direction SPD and each of the third alignment direction AD3″ and the fourth alignment direction AD4″ is 135 degrees or 45 degrees (in other embodiments, the included angle is 135±5 degrees or 45±5 degrees).

For example, the included angle α3 between the third alignment direction AD3″ and the second single-sided privacy protection direction SPD2 may be 135 degrees. The included angle α4 between the fourth alignment direction AD4″ and the second single-sided privacy protection direction SPD2 may be 45 degrees. More specifically, in the embodiment, the third alignment direction AD3″ is parallel to the first alignment direction AD1, and the fourth alignment direction AD4″ is parallel to the second alignment direction AD2.

From another point of view, in the embodiment, the handedness of the twisted arrangement of the first liquid-crystal layer LCL1 of the first electrically-controlled viewing angle switching device 210 between the first alignment layer AL1 and the second alignment layer AL2 and the handedness of the twisted arrangement of the second liquid-crystal layer LCL2 of the second electrically-controlled viewing angle switching device 220B between the third alignment layer AL3″ and the fourth alignment layer ALA″ are both left-handed, for example. The maximum phase retardation of the first liquid-crystal layer LCL1 and the second liquid-crystal layer LCL2 may be greater than 0.8 μm, preferably in the range of 1.04 μm to 1.1 μm. In the embodiment, the maximum phase retardation of each of the first liquid-crystal layer LCL1 and the second liquid-crystal layer LCL2 is, for example, 1.08 μm.

Furthermore, the display apparatus 30 may further include a fourth polarizer POL4 disposed between the first electrically-controlled viewing angle switching device 210 and the second electrically-controlled viewing angle switching device 220B. A half-wave plate WP1″ is located between the second polarizer POL2 and the fourth polarizer POL4. More specifically, the second polarizer POL2 is located between the second alignment layer AL2 and the half-wave plate WP1″ of the first electrically-controlled viewing angle switching device 210, and the fourth polarizer POLA is located between the half-wave plate WP1″ and the third alignment layer AL3″ of the second electrically-controlled viewing angle switching device 220B.

In the embodiment, a third absorption axis AX3″ of a third polarizer POL3″ may be parallel to the second absorption axis AX2 of the second polarizer POL2 and the fourth alignment direction AD4″ of the fourth alignment layer ALA″. The fourth absorption axis AX4 of the fourth polarizer POLA may be parallel to the first absorption axis AX1 of the first polarizer POL1 and the third alignment direction AD3″ of the third alignment layer AL3″. An included angle β3 between the third absorption axis AX3″ and the second single-sided privacy protection direction SPD2 is, for example, 45 degrees, and an included angle β4 between the fourth absorption axis AX4 and the second single-sided privacy protection direction SPD2 is, for example, 135 degrees. Moreover, a slow axis SX″ of the half-wave plate WP1″ of the embodiment may be perpendicular to the first single-sided privacy protection direction SPD1 and the second single-sided privacy protection direction SPD2.

It should be noted that due to the configuration relationship between the first electrically-controlled viewing angle switching device 210 and the second electrically-controlled viewing angle switching device 220B, the display apparatus 30 of the embodiment does not have the compensation film 253 as shown in FIG. 1 between the second electrically-controlled viewing angle switching device 220B and the third polarizer POL3″. Since the remaining members not mentioned are all similar to the display apparatus 10 of FIG. 1, please refer to the related paragraphs of the above embodiments for detailed description, and the remaining members are not described again here.

Please refer to FIG. 7 and FIG. 9. As a comparison, the curve Cc1 is a distribution curve of brightness versus viewing angle of the self-luminous display panel 100. A curve Cs3 is a distribution curve of brightness versus viewing angle when the display apparatus 30 is operated in the sharing mode. A curve Cp3 is a distribution curve of brightness versus viewing angle when the display apparatus 30 is operated in the privacy protection mode.

In the embodiment, when the display apparatus 30 is operated in the sharing mode, neither the first electrically-controlled viewing angle switching device 210 nor the second electrically-controlled viewing angle switching device 220B is enabled. That is, the potential difference between the first alignment layer AL1 and the second alignment layer AL2 and the potential difference between the third alignment layer AL3″ and the fourth alignment layer AL4″ are both 0 V. On the contrary, when the first electrically-controlled viewing angle switching device 210 and the second electrically-controlled viewing angle switching device 220B are both enabled, the display apparatus 30 is operated in the privacy protection mode. For example, when the potential difference between the first alignment layer AL1 and the second alignment layer AL2 is 2.8 V and the potential difference between the third alignment layer AL3″ and the fourth alignment layer AL4″ is 2.5 V, the distribution curve of brightness versus viewing angle of the display apparatus 30 operated in the privacy protection mode is the curve Cp3 of FIG. 9.

As may be seen from FIG. 9, the display apparatus 30 operated in the privacy protection mode only has a significant privacy protection effect within the left viewing angle range. This is because the first electrically-controlled viewing angle switching device 210 and the second electrically-controlled viewing angle switching device 220B of the embodiment respectively have the first single-sided privacy protection direction SPD1 and the second single-sided privacy protection direction SPD2 that are in the same direction as each other.

It should be noted that the display apparatus 30 of the embodiment is also applicable to a vehicle-mounted personal display. Compared with the display apparatus 10 of FIG. 1, the display apparatus 30 of the embodiment may drive the electrically-controlled viewing angle switching devices with lower voltage and has a better privacy protection effect on the driver's side. In addition, in the embodiment, when the display apparatus 30 is switched between the sharing mode and the privacy protection mode, the change in display brightness at the front viewing angle is relatively insensitive to users (such as the passenger in the front passenger seat). In other words, compared with the display apparatus 10 of FIG. 1, the display apparatus 30 of the embodiment may further improve the user's operating experience.

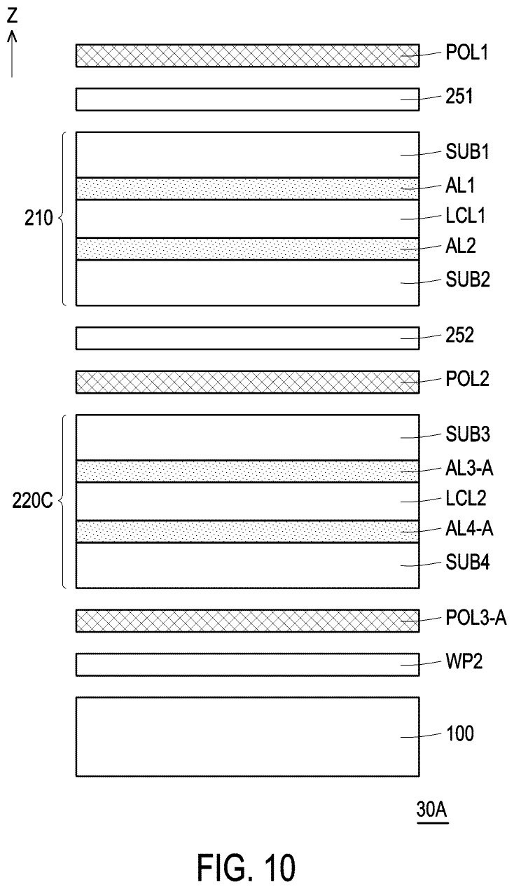

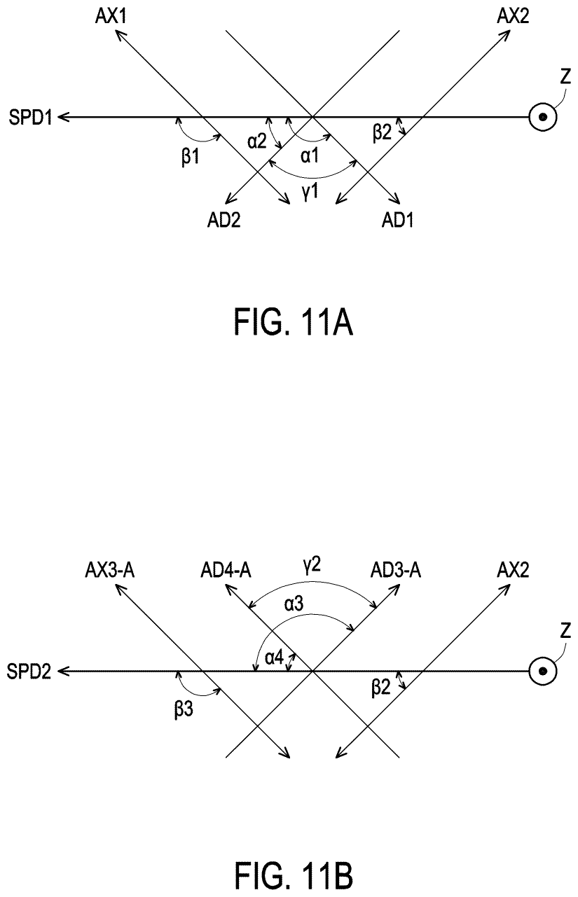

FIG. 10 is a schematic cross-sectional view of a display apparatus according to the fourth embodiment of the disclosure. FIG. 11A and FIG. 11B are schematic views of the arrangement relationship between the alignment direction of the alignment layer and the axial direction of the absorption axis of the polarizer of FIG. 10.

Please refer to FIG. 10, FIG. 11A, and FIG. 11B. The main difference between a display apparatus 30A of the embodiment and the display apparatus 30 of FIG. 7 is the design of the second electrically-controlled viewing angle switching device is different. Specifically, in the embodiment, the handedness of the twisted arrangement of the second liquid-crystal layer LCL2 of the second electrically-controlled viewing angle switching device 220C between a third alignment layer AL3-A and a fourth alignment layer AL4-A is different from the handedness of the twisted arrangement of the first liquid-crystal layer LCL1 of the first electrically-controlled viewing angle switching device 210 between the first alignment layer AL1 and the second alignment layer AL2.

In detail, the included angle α3 between the second single-sided privacy protection direction SPD2 and a third alignment direction AD3-A of the third alignment layer AL3-A may be 135 degrees. The included angle α4 between the second single-sided privacy protection direction SPD2 and a third alignment direction AD4-A of the fourth alignment layer AL4-A may be 45 degrees. More specifically, in the embodiment, the third alignment direction AD3-A is anti-parallel to the second alignment direction AD2, and the fourth alignment direction AD4-A is anti-parallel to the first alignment direction AD1.

From another point of view, in the embodiment, the handedness of the twisted arrangement of the second liquid-crystal layer LCL2 of the second electrically-controlled viewing angle switching device 220C between the third alignment layer AL3-A and the fourth alignment layer AL4-A is, for example, right-handed rotation, and the handedness of the twisted arrangement of the first liquid-crystal layer LCL1 of the first electrically-controlled viewing angle switching device 210 between the first alignment layer AL1 and the second alignment layer AL2 is, for example, left-handed rotation.

In the embodiment, the third absorption axis AX3-A of the third polarizer POL3-A may be parallel to the first absorption axis AX1 of the first polarizer POL1 and the fourth alignment direction AD4-A of the fourth alignment layer AL4-A. The included angle β3 between the third absorption axis AX3-A and the second single-sided privacy protection direction SPD2 is, for example, 135 degrees.

It should be noted that, since the first liquid-crystal layer LCL1 of the first electrically-controlled viewing angle switching device 210 and the second liquid-crystal layer LCL2 of the second electrically-controlled viewing angle switching device 220C are different from each other in the handedness of the twisted arrangement, the half-wave plate WP1 and the fourth polarizer POLA as shown in FIG. 7 do not need to be provided between the first electrically-controlled viewing angle switching device 210 and the second electrically-controlled viewing angle switching device 220C of the display apparatus 30A of the embodiment. As a result, not only is the architecture of the display apparatus 30A simplified, but the energy consumption performance thereof is also improved.

Since the remaining members not mentioned are all similar to the display apparatus 30 of FIG. 7, please refer to the related paragraphs of the above embodiments for detailed description, and the remaining members are not described again here.

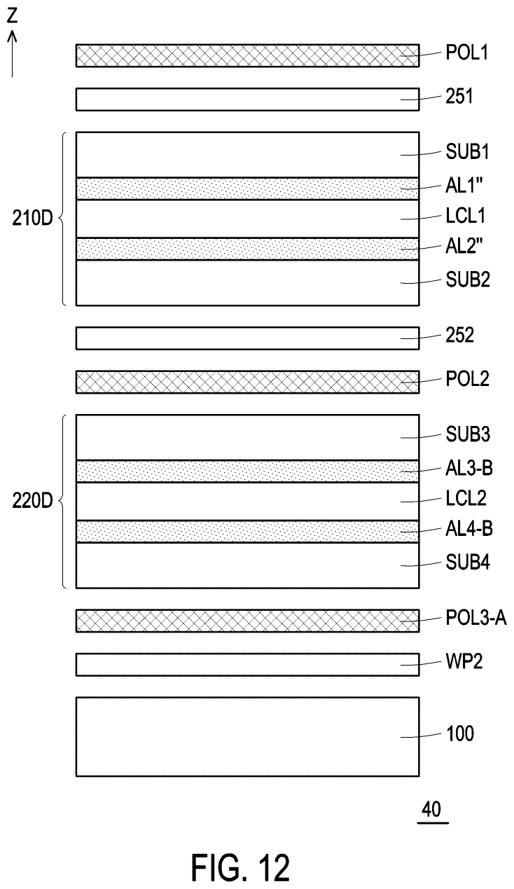

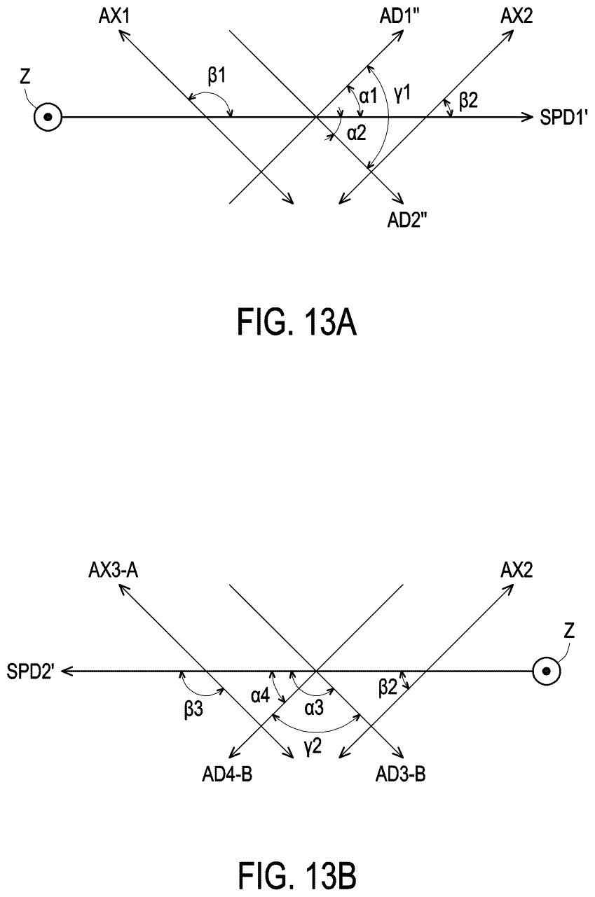

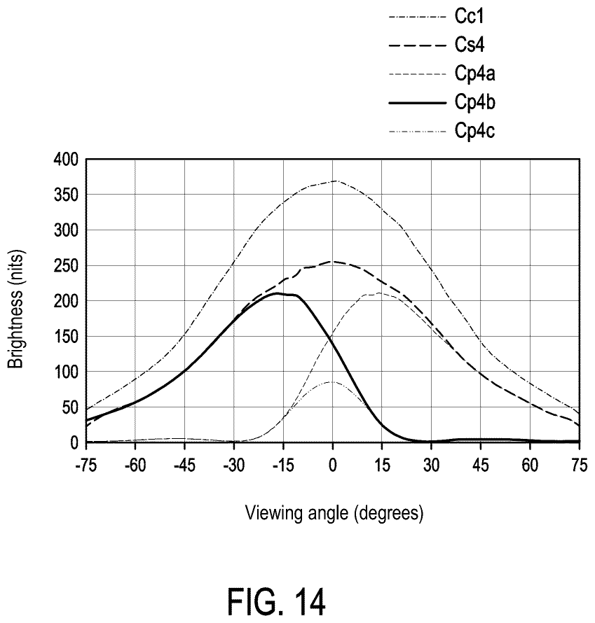

FIG. 12 is a schematic cross-sectional view of a display apparatus according to the fifth embodiment of the disclosure. FIG. 13A and FIG. 13B are schematic views of the arrangement relationship between the alignment direction of the alignment layer and the axial direction of the absorption axis of the polarizer of FIG. 12. FIG. 14 is a graph of brightness versus viewing angle of the display apparatus of FIG. 12 operated in different display modes.

Please refer to FIG. 12, FIG. 13A, and FIG. 13B. The main difference between a display apparatus 40 of the embodiment and the display apparatus 30A of FIG. 10 is the design of the electrically-controlled viewing angle switching device is different. Specifically, in the embodiment, a first single-sided privacy protection direction SPD1′ of the first electrically-controlled viewing angle switching device 210D is anti-parallel to a second single-sided privacy protection direction SPD2′ of the second electrically-controlled viewing angle switching device 220D.

In the embodiment, the included angle α1 between a first alignment direction AD1″ of a first alignment layer AL1″ and the first single-sided privacy protection direction SPD1′ may be 45 degrees. The included angle α2 between the first single-sided privacy protection direction SPD1′ and a second alignment direction AD2″ of a second alignment layer AL2″ may be 45 degrees. More specifically, the first alignment direction AD1″ may be perpendicular to the first absorption axis AX1 of the first polarizer POL1, and the second alignment direction AD2″ may be perpendicular to the second absorption axis AX2 of the second polarizer POL2. Therefore, the first single-sided privacy protection direction SPD1′ of the first electrically-controlled viewing angle switching device 210D of the embodiment is toward the right side of FIG. 13A.

The included angle α3 between a third alignment direction AD3-B of a third alignment layer AL3-B and the second single-sided privacy protection direction SPD2′ may be 135 degrees. The included angle α4 between a fourth alignment direction AD4-B of a fourth alignment layer AL4-B and the second single-sided privacy protection direction SPD2′ may be 45 degrees. More specifically, the third alignment direction AD3-B may be parallel to the second alignment direction AD2″, and the fourth alignment direction AD4-B may be anti-parallel to the first alignment direction AD1″. Therefore, the second single-sided privacy protection direction SPD2′ of the second electrically-controlled viewing angle switching device 220D of the embodiment is toward the left side of FIG. 13B (for example, −90 degrees).

From another point of view, in the embodiment, the handedness of the twisted arrangement of the first liquid-crystal layer LCL1 of the first electrically-controlled viewing angle switching device 210D between the first alignment layer AL1″ and the second alignment layer AL2″ and the handedness of the twisted arrangement of the second liquid-crystal layer LCL2 of the second electrically-controlled viewing angle switching device 220D between the third alignment layer AL3-B and the fourth alignment layer AL4-B are both left-handed, for example.

Since the remaining members not mentioned are all similar to the display apparatus 30A of FIG. 10, please refer to the related paragraphs of the above embodiments for detailed description, and the remaining members are not described again here.

Please refer to FIG. 12 and FIG. 14. As a comparison, the curve Cc1 is a distribution curve of brightness versus viewing angle of the self-luminous display panel 100. A curve Cs4 is a distribution curve of brightness versus viewing angle when the display apparatus 40 is operated in the sharing mode. A curve Cp4a is a distribution curve of brightness versus viewing angle when the display apparatus 40 is operated in the first privacy protection mode. A curve Cp4b is a distribution curve of brightness versus viewing angle when the display apparatus 40 is operated in the second privacy protection mode. A curve Cp4c is a distribution curve of brightness versus viewing angle when the display apparatus 40 is operated in the third privacy protection mode.

In the embodiment, when the display apparatus 40 is operated in the sharing mode, neither the first electrically-controlled viewing angle switching device 210D nor the second electrically-controlled viewing angle switching device 220D is enabled. That is, the potential difference between the first alignment layer AL1″ and the second alignment layer AL2″ and the potential difference between the third alignment layer AL3-B and the fourth alignment layer AL4-B are both 0 V. On the contrary, when at least one of the first electrically-controlled viewing angle switching device 210D and the second electrically-controlled viewing angle switching device 220D is enabled, the display apparatus 40 is operated in the privacy protection mode.

For example, when the potential difference between the first alignment layer AL1″ and the second alignment layer AL2″ is 0 V and the potential difference between the third alignment layer AL3-B and the fourth alignment layer AL4-B is 2.8 V, the distribution curve of brightness versus viewing angle of the display apparatus 40 operated in the first privacy protection mode is the curve Cp4a of FIG. 14. When the potential difference between the first alignment layer AL1″ and the second alignment layer AL2″ is 2.9 V and the potential difference between the third alignment layer AL3-B and the fourth alignment layer AL4-B is 0 V, the distribution curve of brightness versus viewing angle of the display apparatus 40 operated in the second privacy protection mode is the curve Cp4b of FIG. 14. When the potential difference between the first alignment layer AL1″ and the second alignment layer AL2″ is 2.9 V and the potential difference between the third alignment layer AL3-B and the fourth alignment layer AL4-B is 2.9 V, the distribution curve of brightness versus viewing angle of the display apparatus 40 operated in the third privacy protection mode is the curve Cp4c of FIG. 14.

As may be seen from FIG. 14, in the embodiment, when one of the first electrically-controlled viewing angle switching device 210D and the second electrically-controlled viewing angle switching device 220D is enabled, the display apparatus 40 may be operated in a single-sided privacy protection mode (e.g., a first privacy protection mode (as shown in the curve Cp4a of FIG. 14) and a second privacy protection mode (as shown in the curve Cp4b of FIG. 14)). When both the first electrically-controlled viewing angle switching device 210D and the second electrically-controlled viewing angle switching device 220D are enabled, the display apparatus 40 may be operated in a double-sided privacy protection mode (i.e., the third privacy protection mode) (as shown in the curve Cp4c of FIG. 14)).

That is, the display apparatus 40 of the embodiment may meet the privacy protection requirements in different usage scenarios by adjusting the number of active electrically-controlled viewing angle switching devices and the voltages thereof. Since the display apparatus 40 of the embodiment has both single-sided privacy protection and double-sided privacy protection functions capable of electronic switching, the display apparatus 40 of the embodiment may also be applied to a notebook computer in addition to a vehicle-mounted display. For example, the notebook computer may instantly obtain the number and location of peepers via a camera, and accordingly, adjust the voltage of the first electrically-controlled viewing angle switching device 210D and/or the second electrically-controlled viewing angle switching device 220D of the display apparatus 40 to dynamically adjust the privacy protection range. The privacy protection range here may be distributed on one side or both sides of the user.

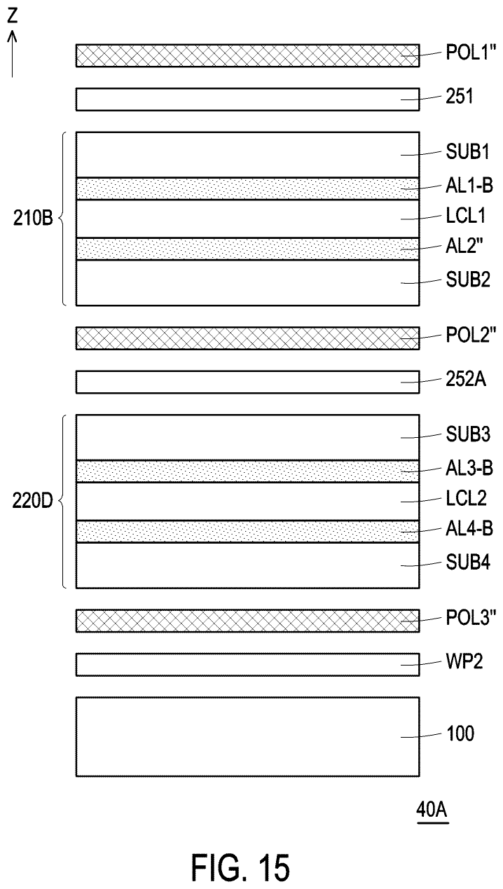

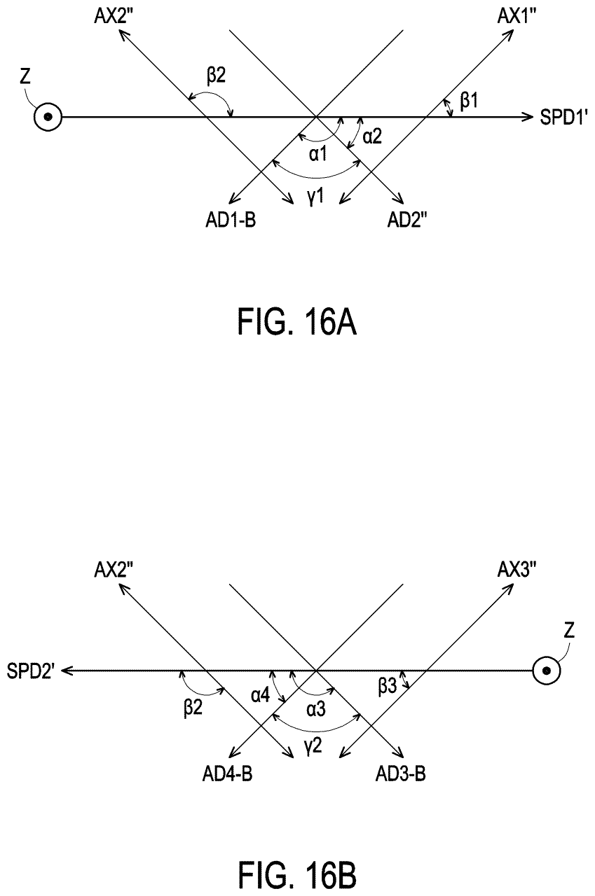

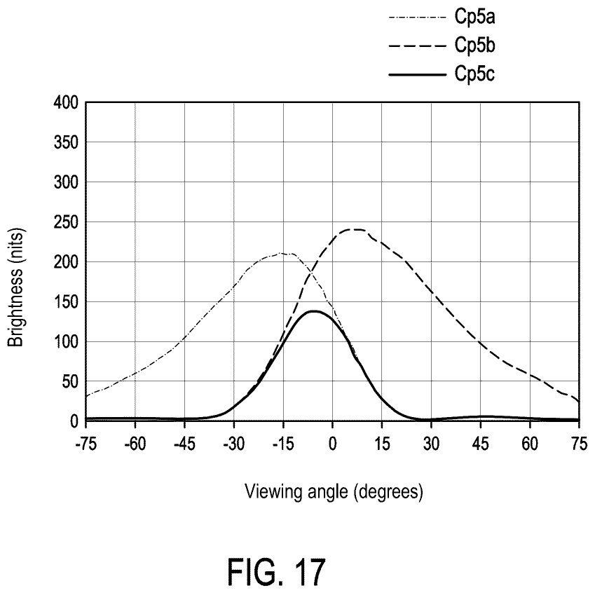

FIG. 15 is a schematic cross-sectional view of a display apparatus according to the sixth embodiment of the disclosure. FIG. 16A and FIG. 16B are schematic views of the arrangement relationship between the alignment direction of the alignment layer and the axial direction of the absorption axis of the polarizer of FIG. 15. FIG. 17 is a graph of brightness versus viewing angle of the display apparatus of FIG. 15 operated in different display modes.

Please refer to FIG. 15, FIG. 16A, and FIG. 16B. The main difference between a display apparatus 40A of the embodiment and the display apparatus 40 of FIG. 12 is the design of the first electrically-controlled viewing angle switching device is different. Specifically, in the embodiment, the handedness of the twisted arrangement of the second liquid-crystal layer LCL2 of the second electrically-controlled viewing angle switching device 220D between the third alignment layer AL3-B and the fourth alignment layer ALA-B is different from the handedness of the twisted arrangement of the first liquid-crystal layer LCL1 of the first electrically-controlled viewing angle switching device 210B between the first alignment layer AL1-B and the second alignment layer AL2″.

In detail, the included angle α1 between the first single-sided privacy protection direction SPD1′ and the first alignment direction AD1-B of the first alignment layer AL1-B may be 135 degrees. The included angle α2 between the first single-sided privacy protection direction SPD1′ and the second alignment direction AD2″ of the second alignment layer AL2″ may be 45 degrees. More specifically, in the embodiment, the first alignment direction AD1-B is parallel to the fourth alignment direction AD4-B, and the second alignment direction AD2″ is parallel to the third alignment direction AD3-B.

From another point of view, in the embodiment, the handedness of the twisted arrangement of the first liquid-crystal layer LCL1 of the first electrically-controlled viewing angle switching device 210B between the first alignment layer AL1-B and the second alignment layer AL2″ is right-handed, for example, and the handedness of the twisted arrangement of the second liquid-crystal layer LCL2 of the second electrically-controlled viewing angle switching device 220D between the third alignment layer AL3-A and the fourth alignment layer AL4-A is left-handed, for example.

In the embodiment, the first absorption axis AX1″ of the first polarizer POL1″ is parallel to the first alignment direction AD1-B of the first alignment layer AL1-B. The second absorption axis AX2″ of the second polarizer POL2″ is parallel to the second alignment direction AD2″ of the second alignment layer AL2″. The third absorption axis AX3″ of the third polarizer POL3″ is parallel to the fourth alignment direction AD4-B of the fourth alignment layer AL4-B.

It should be noted that, different from the compensation film 252 of FIG. 12 disposed between the second polarizer POL2 and the first electrically-controlled viewing angle switching device 210D, the compensation film 252A of the embodiment is disposed between the second polarizer POL2″ and the second electrically-controlled viewing angle switching device 220D. In the embodiment, the sum of out-of-plane phase retardations of the compensation film 251 located between the first polarizer POL1″ and the first electrically-controlled viewing angle switching device 210B and the compensation film 252A located between the second polarizer POL2″ and the second electrically-controlled viewing angle switching device 220D may be −200 nm.

Since the remaining members not mentioned are all similar to the display apparatus 40 of FIG. 12, please refer to the related paragraphs of the above embodiments for detailed description, and the remaining members are not described again here.

Please refer to FIG. 15 and FIG. 17. A curve Cp5a is a distribution curve of brightness versus viewing angle when the display apparatus 40A is operated in the first privacy protection mode. A curve Cp5b is a distribution curve of brightness versus viewing angle when the display apparatus 40A is operated in the second privacy protection mode. A curve Cp5c is a distribution curve of brightness versus viewing angle when the display apparatus 40A is operated in the third privacy protection mode.

For example, when the potential difference between the first alignment layer AL1-B and the second alignment layer AL2″ is 3.0 V and the potential difference between the third alignment layer AL3-B and the fourth alignment layer AL4-B is 0 V, the distribution curve of brightness versus viewing angle of the display apparatus 40A operated in the first privacy protection mode is the curve Cp5a of FIG. 17. When the potential difference between the first alignment layer AL1-B and the second alignment layer AL2″ is 2.7 V and the potential difference between the third alignment layer AL3-B and the fourth alignment layer AL4-B is 0 V, the distribution curve of brightness versus viewing angle of the display apparatus 40A operated in the second privacy protection mode is the curve Cp5b of FIG. 17. When the potential difference between the first alignment layer AL1-B and the second alignment layer AL2″ is 3.0 V and the potential difference between the third alignment layer AL3-B and the fourth alignment layer AL4-B is 2.7 V, the distribution curve of brightness versus viewing angle of the display apparatus 40A operated in the third privacy protection mode is the curve Cp5c of FIG. 17.

As may be seen from FIG. 17, in the embodiment, when one of the first electrically-controlled viewing angle switching device 210B and the second electrically-controlled viewing angle switching device 220D is enabled, the display apparatus 40A may be operated in a single-sided privacy protection mode (e.g., a first privacy protection mode (as shown in the curve Cp5a of FIG. 17) and a second privacy protection mode (as shown in the curve Cp5b of FIG. 17)). When both the first electrically-controlled viewing angle switching device 210B and the second electrically-controlled viewing angle switching device 220D are enabled, the display apparatus 40A may be operated in a double-sided privacy protection mode (i.e., the third privacy protection mode) (as shown in the curve Cp5c of FIG. 17)).

It should be noted that, similar to the display apparatus 40 of FIG. 12, the display apparatus 40A of the embodiment may also be applied to the display of a notebook computer. For example, when a notebook computer detects via a camera that someone is watching the screen 45 degrees to the left and 30 degrees to the right of the user, the voltages of the first electrically-controlled viewing angle switching device 210B and the second electrically-controlled viewing angle switching device 220D are adjusted individually, so that the best privacy protection viewing angles thereof are moved to −45 degrees and 30 degrees respectively, thereby optimizing the privacy protection effect.

Compared with the privacy protection films currently used in notebook computers with fixed privacy protection angles, the display apparatus 40 of FIG. 12 and the display apparatus 40A of FIG. 15 are more flexible in adjusting the privacy protection performance.

It should be noted that during the assembly process of the display apparatus of each embodiment above, optical adhesive may be used to fully bond the first electrically-controlled viewing angle switching device and the second electrically-controlled viewing angle switching device. However, the disclosure is not limited thereto.

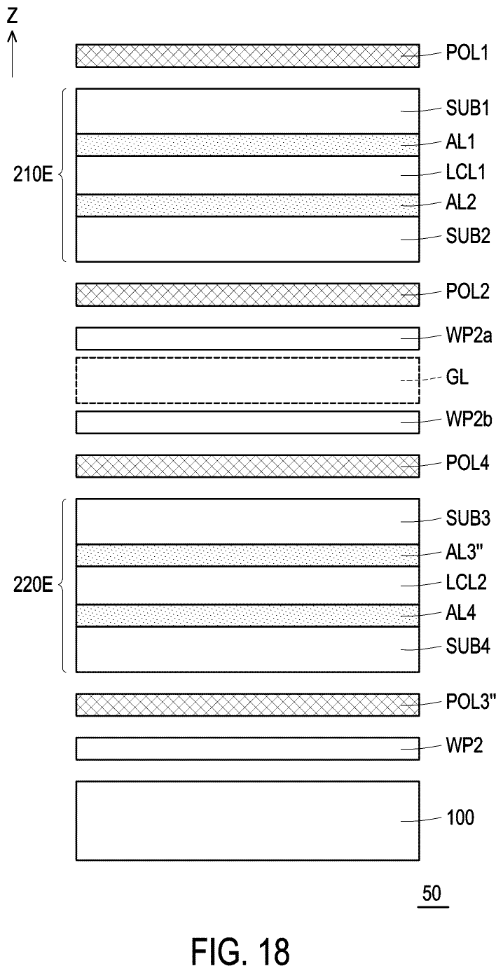

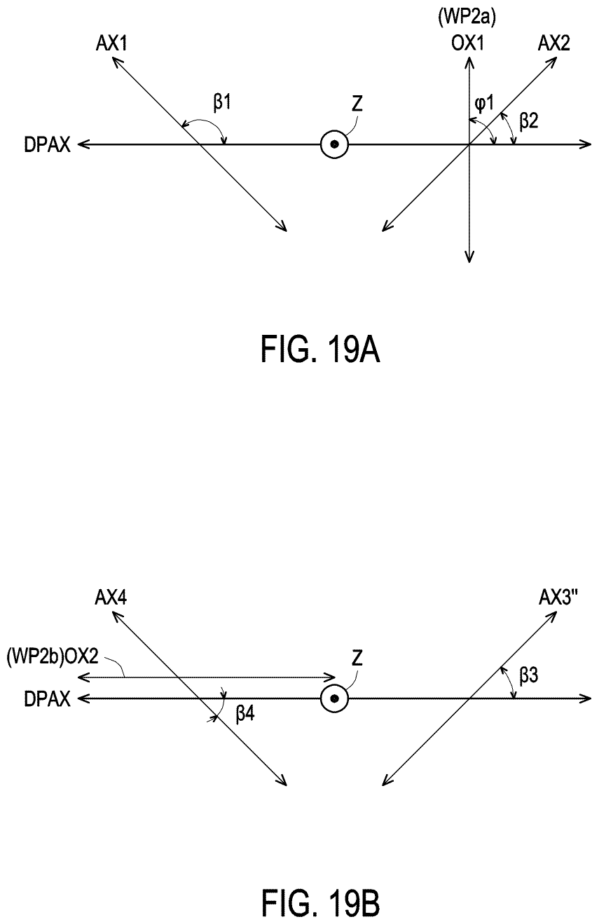

FIG. 18 is a schematic cross-sectional view of a display apparatus according to the seventh embodiment of the disclosure. FIG. 19A and FIG. 19B are schematic views of the arrangement relationship between the alignment direction of the alignment layer, the axial direction of the absorption axis of the polarizer, and the axial direction of the optical axis of the quarter-wave plate of FIG. 18.

Please refer to FIG. 18, FIG. 19A, and FIG. 19B. In a display apparatus 50 of the embodiment, a gap layer GL may also be provided between the first electrically-controlled viewing angle switching device 210E and the second electrically-controlled viewing angle switching device 220E. That is, the two electrically-controlled viewing angle switching devices are not assembled in a fully bond manner. In order to reduce light reflection at the interface of the gap layer GL and the polarizer or the electrically-controlled viewing angle switching device that affects the display effect, the display apparatus 50 may also be provided with a first quarter-wave plate WP2a and a second quarter-wave plate WP2b respectively on two opposite sides of the gap layer GL.

In the embodiment, the first quarter-wave plate WP2a is disposed between the second alignment layer AL2 and the gap layer GL, and the second polarizer POL2 is disposed between the first quarter-wave plate WP2a and the first electrically-controlled viewing angle switching device 210E. The second quarter-wave plate WP2b is disposed between the third alignment layer AL3″ and the gap layer GL, and the fourth polarizer POL4 is disposed between the second quarter-wave plate WP2b and the second electrically-controlled viewing angle switching device 220E.

In the embodiment, the first electrically-controlled viewing angle switching device 210E and the second electrically-controlled viewing angle switching device 220E may have the same privacy protection axial direction. The privacy protection axial direction is, for example, the double-sided privacy protection axial direction DPAX, but the disclosure is not limited thereto. In other modified embodiments, the privacy protection axial direction may also be a single-sided privacy protection direction. In the embodiment, the second absorption axis AX2 of the second polarizer POL2 has the included angle β2 with respect to the double-sided privacy protection axial direction DPAX (90-degree direction), and the double-sided privacy protection axial direction DPAX (90-degree direction) has the included angle β4 with respect to the fourth absorption axis AX4 of the fourth polarizer POLA.

It should be noted that the two included angles of the first optical axis OX1 of the first quarter-wave plate WP2a and the second optical axis OX2 of the second quarter-wave plate WP2b with respect to the double-sided privacy protection axial direction DPAX are respectively β2+45 degrees and β4−45 degrees or β2−45 degrees and β4+45 degrees. For example, in the embodiment, the included angle β2 and the included angle β4 are both 45 degrees. Therefore, the included angle σ1 between the first optical axis OX1 and the double-sided privacy protection axial direction DPAX (90-degree direction) is 90 degrees, and the included angle (not shown) between the second optical axis OX2 and the double-sided privacy protection axial direction DPAX is 0 degrees. That is, the first optical axis OX1 is perpendicular to the double-sided privacy protection axial direction DPAX, and the second optical axis OX2 is parallel to the double-sided privacy protection axial direction DPAX, but the disclosure is not limited thereto. In other embodiments, the included angle σ1 may be 0 degrees, and the included angle between the second optical axis OX2 and the double-sided privacy protection axial direction DPAX may be 90 degrees.

It should be noted that the axial directions of the plurality of absorption axes and the relative relationships thereof shown in FIG. 19A and FIG. 19B are all for illustrative purposes only, and the disclosure is not limited to the content shown in the drawings.

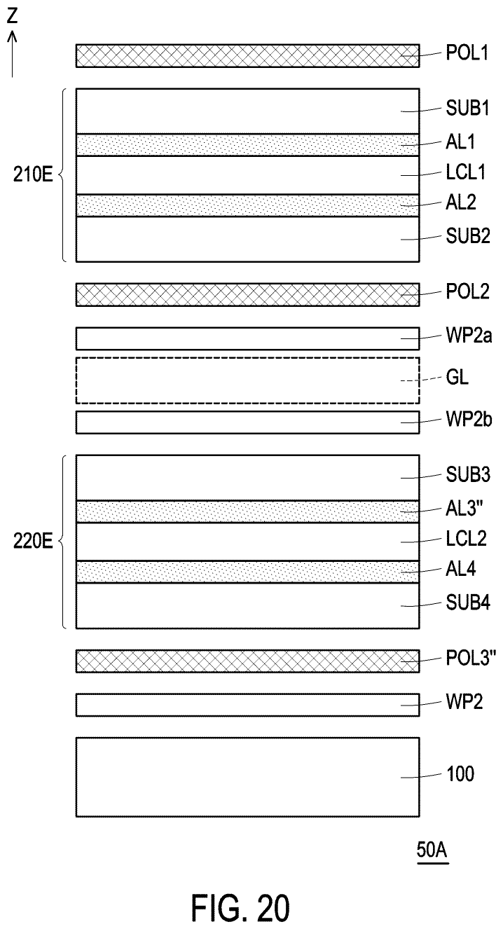

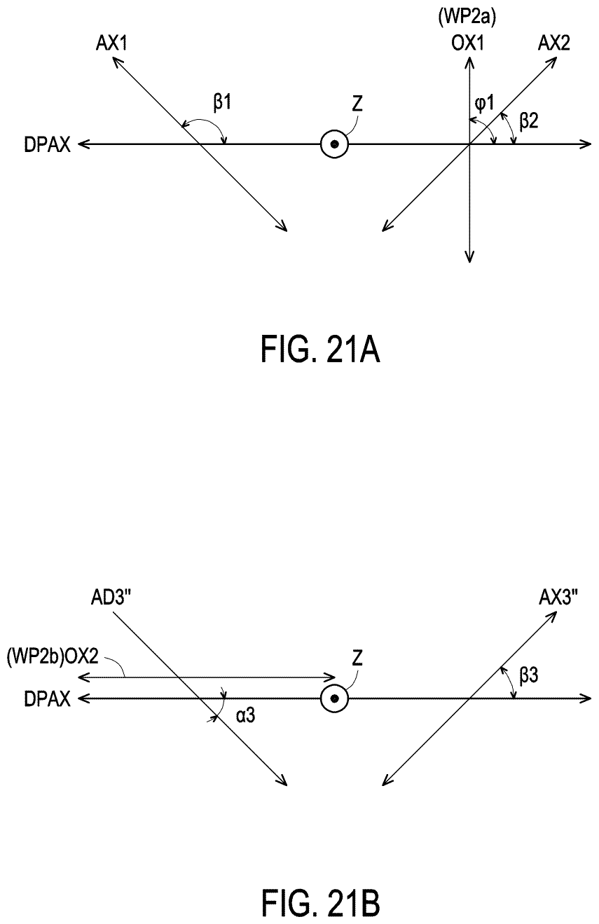

FIG. 20 is a schematic cross-sectional view of a display apparatus according to the eighth embodiment of the disclosure. FIG. 21A and FIG. 21B are schematic views of the arrangement relationship between the alignment direction of the alignment layer, the axial direction of the absorption axis of the polarizer, and the axial direction of the optical axis of the quarter-wave plate of FIG. 20.

Please refer to FIG. 20, FIG. 21A, and FIG. 21B. The only difference between a display apparatus 50A of the embodiment and the display apparatus 50 of FIG. 18 is: the display apparatus 50A of the embodiment does not have the fourth polarizing layer POLA as shown in FIG. 18 between the second quarter-wave plate WP2b and the third alignment layer AL3″. Therefore, the included angle between the second optical axis OX2 of the second quarter-wave plate WP2b and the double-sided privacy protection axial direction DPAX is instead defined by the third alignment direction AD3″ of the third alignment layer AL3″.

For example, there is the included angle α3 between the double-sided privacy protection axial direction DPAX (90-degree direction) and the third alignment direction AD3″. Accordingly, the included angle between the second optical axis OX2 and the double-sided privacy protection axial direction DPAX may be α3−45 degrees or α3+45 degrees. In the embodiment, the included angle α3 is 45 degrees. Therefore, the included angle between the second optical axis OX2 and the double-sided privacy protection axial direction DPAX may be 0 degrees (as shown in FIG. 21B) or 90 degrees.

Based on the above, in the display apparatus according to an embodiment of the disclosure, the display surface of the self-luminous display panel is provided with the electrically controllable first liquid-crystal layer and second liquid-crystal layer. The alignment direction of the first liquid-crystal layer at a side of the first alignment layer is parallel or perpendicular to the first absorption axis of the adjacent first polarizer. The alignment direction of the second liquid-crystal layer at a side of the fourth alignment layer is parallel or perpendicular to the third absorption axis of the adjacent third polarizer. The second polarizer is also disposed between the first liquid-crystal layer and the second liquid-crystal layer. Via the above configuration, the display apparatus of an embodiment of the disclosure has at least one of the following advantages: the viewing angle range in at least one direction may be electronically switched to meet different usage scenarios, and may reduce light leakage of the display apparatus within the privacy protection viewing angle range.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no clement and component in the disclosure is intended to be dedicated to the public regardless of whether the element or component is explicitly recited in the following claims.

What is claimed is:

1. A display apparatus, comprising a self-luminous display panel, a first electrically-controlled viewing angle switching device, a second electrically-controlled viewing angle switching device, a first polarizer, a second polarizer, and a third polarizer, wherein:
the first electrically-controlled viewing angle switching device is disposed at a side of a display surface of the self-luminous display panel and comprises a first liquid-crystal layer, a first alignment layer, and a second alignment layer, wherein the first liquid-crystal layer is disposed between the first alignment layer and the second alignment layer;
the second electrically-controlled viewing angle switching device is disposed between the first electrically-controlled viewing angle switching device and the self-luminous display panel, and comprises a second liquid-crystal layer, a third alignment layer, and a fourth alignment layer, wherein the second liquid-crystal layer is disposed between the third alignment layer and the fourth alignment layer;
the first polarizer is disposed at a side of the first electrically-controlled viewing angle switching device facing away from the second electrically-controlled viewing angle switching device, and has a first absorption axis, wherein the first alignment layer is located between the first liquid-crystal layer and the first polarizer, and an axial direction of the first absorption axis is parallel or perpendicular to a first alignment direction of the first alignment layer;
the second polarizer is disposed between the first electrically-controlled viewing angle switching device and the second electrically-controlled viewing angle switching device, and has a second absorption axis;
the third polarizer is disposed between the self-luminous display panel and the second electrically-controlled viewing angle switching device, and has a third absorption axis, wherein the fourth alignment layer is located between the second liquid-crystal layer and the third polarizer, and an axial direction of the third absorption axis is parallel or perpendicular to a fourth alignment direction of the fourth alignment layer.

2. The display apparatus of claim 1, wherein the display apparatus further comprises a quarter-wave plate, the quarter-wave plate is disposed between the self-luminous display panel and the third polarizer, and an included angle between an optical axis of the quarter-wave plate and the third absorption axis of the third polarizer is 45 degrees.

3. The display apparatus of claim 2, wherein the display apparatus further comprises a half-wave plate, and the half-wave plate is disposed between the first electrically-controlled viewing angle switching device and the second electrically-controlled viewing angle switching device.

4. The display apparatus of claim 3, wherein the first electrically-controlled viewing angle switching device has a single-sided privacy protection direction, the second electrically-controlled viewing angle switching device has a double-sided privacy protection axial direction, the single-sided privacy protection direction is parallel to the double-sided privacy protection axial direction, the first alignment direction of the first alignment layer is perpendicular to a second alignment direction of the second alignment layer, an included angle between the single-sided privacy protection direction and each of the first alignment direction and the second alignment direction is 45±5 degrees or 135±5 degrees, an included angle between the double-sided privacy protection axial direction and each of a third alignment direction of the third alignment layer and the fourth alignment direction is between 75 degrees and 105 degrees, and an included angle between the third alignment direction and the fourth alignment direction is less than or equal to 30 degrees.

5. The display apparatus of claim 4, wherein the axial direction of the first absorption axis is perpendicular to an axial direction of the second absorption axis, and an included angle between the single-sided privacy protection direction and each of the first absorption axis and the second absorption axis is 45±5 degrees or 135±5 degrees.

6. The display apparatus of claim 5, wherein an included angle between the third absorption axis and the double-sided privacy protection axial direction is greater than or equal to 0 degrees and less than or equal to 15 degrees, or greater than or equal to 90 degrees and less than 105 degrees.

7. The display apparatus of claim 5, wherein the second absorption axis has an included angle β2 with respect to the double-sided privacy protection axial direction, the third alignment direction has an included angle α3 with respect to the double-sided privacy protection axial direction, and an included angle between a slow axis of the half-wave plate and the double-sided privacy protection axial direction is (α3+β2+90 degrees)/2 or (α3+β2+90 degrees)/2+90 degrees.

8. The display apparatus of claim 3, wherein the first electrically-controlled viewing angle switching device has a first single-sided privacy protection direction, the second electrically-controlled viewing angle switching device has a second single-sided privacy protection direction, the first single-sided privacy protection direction is parallel to the second single-sided privacy protection direction, the first alignment direction of the first alignment layer is perpendicular to a second alignment direction of the second alignment layer, a third alignment direction of the third alignment layer is perpendicular to the fourth alignment direction of the fourth alignment layer, an included angle between the first single-sided privacy protection direction and each of the first alignment direction, the second alignment direction, the third alignment direction, and the fourth alignment direction is 45±5 degrees or 135±5 degrees, the first alignment direction is parallel to the third alignment direction, and the second alignment direction is parallel to the fourth alignment direction.

9. The display apparatus of claim 8, wherein the display apparatus further comprises a fourth polarizer, and the fourth polarizer is disposed between the first electrically-controlled viewing angle switching device and the second electrically-controlled viewing angle switching device, wherein the half-wave plate is located between the second polarizer and the fourth polarizer, and a fourth absorption axis of the fourth polarizer is perpendicular to the second absorption axis of the second polarizer.

10. The display apparatus of claim 9, wherein the second polarizer is located between the second alignment layer and the half-wave plate, the fourth polarizer is located between the third alignment layer and the half-wave plate, the first absorption axis, the fourth absorption axis, the first alignment direction, and the third alignment direction are parallel to each other, and the second absorption axis, the third absorption axis, the second alignment direction, and the fourth alignment direction are parallel to each other.

11. The display apparatus of claim 2, wherein the first electrically-controlled viewing angle switching device and the second electrically-controlled viewing angle switching device have a double-sided privacy protection axis, an included angle between the first alignment direction of the first alignment layer and a second alignment direction of the second alignment layer is less than or equal to 30 degrees, an included angle between a third alignment direction of the third alignment layer and the fourth alignment direction of the fourth alignment layer is less than or equal to 30 degrees, the first alignment direction and the fourth alignment direction are perpendicular to the double-sided privacy protection axis, and the second alignment direction is parallel to the third alignment direction.

12. The display apparatus of claim 11, wherein each of the first absorption axis and the third absorption axis is parallel to the double-sided privacy protection axis, and an included angle between the second absorption axis and the double-sided privacy protection axis is greater than or equal to 0 degrees and less than or equal to 15 degrees, or greater than or equal to 90 degrees and less than 105 degrees.

13. The display apparatus of claim 2, wherein the first electrically-controlled viewing angle switching device has a first single-sided privacy protection direction, the second electrically-controlled viewing angle switching device has a second single-sided privacy protection direction, the first single-sided privacy protection direction is parallel to the second single-sided privacy protection direction, the first alignment direction of the first alignment layer is perpendicular to a second alignment direction of the second alignment layer, a third alignment direction of the third alignment layer is perpendicular to the fourth alignment direction of the fourth alignment layer, an included angle between the first single-sided privacy protection direction and each of the first alignment direction, the second alignment direction, the third alignment direction, and the fourth alignment direction is 45±5 degrees or 135±5 degrees, the first alignment direction is anti-parallel to the fourth alignment direction, and the second alignment direction is anti-parallel to the third alignment direction.

14. The display apparatus of claim 13, wherein the first absorption axis is parallel to the first alignment direction, the second absorption axis is parallel to the second alignment direction, and the third absorption axis is parallel to the fourth alignment direction.

15. The display apparatus of claim 2, wherein the first electrically-controlled viewing angle switching device has a first single-sided privacy protection direction, the second electrically-controlled viewing angle switching device has a second single-sided privacy protection direction, the first single-sided privacy protection direction is anti-parallel to the second single-sided privacy protection direction, the first alignment direction of the first alignment layer is perpendicular to a second alignment direction of the second alignment layer, a third alignment direction of the third alignment layer is perpendicular to the fourth alignment direction of the fourth alignment layer, an included angle between the first single-sided privacy protection direction and each of the first alignment direction, the second alignment direction, the third alignment direction, and the fourth alignment direction is 45±5 degrees or 135±5 degrees, the first alignment direction is anti-parallel to the fourth alignment direction, and the second alignment direction is parallel to the third alignment direction.

16. The display apparatus of claim 15, wherein the first absorption axis is parallel to the second alignment direction, the second absorption axis is parallel to the first alignment direction, and the third absorption axis is parallel to the third alignment direction.

17. The display apparatus of claim 2, wherein the first electrically-controlled viewing angle switching device has a first single-sided privacy protection direction, the second electrically-controlled viewing angle switching device has a second single-sided privacy protection direction, the first single-sided privacy protection direction is anti-parallel to the second single-sided privacy protection direction, the first alignment direction of the first alignment layer is perpendicular to a second alignment direction of the second alignment layer, a third alignment direction of the third alignment layer is perpendicular to the fourth alignment direction of the fourth alignment layer, an included angle between the first single-sided privacy protection direction and each of the first alignment direction, the second alignment direction, the third alignment direction, and the fourth alignment direction is 45±5 degrees or 135±5 degrees, the first alignment direction is parallel to the fourth alignment direction, and the second alignment direction is parallel to the third alignment direction.

18. The display apparatus of claim 17, wherein the first absorption axis is parallel to the first alignment direction, the second absorption axis is parallel to the second alignment direction, and the third absorption axis is parallel to the fourth alignment direction.

19. The display apparatus of claim 1, wherein the display apparatus further comprises a gap layer, a first quarter-wave plate, and a second quarter-wave plate, wherein:
the gap layer is disposed between the first electrically-controlled viewing angle switching device and the second electrically-controlled viewing angle switching device;
the first quarter-wave plate is disposed between the second alignment layer and the gap layer;
the second quarter-wave plate is disposed between the gap layer and the third alignment layer.

20. The display apparatus of claim 19, wherein the second polarizer is disposed between the second alignment layer and the first quarter-wave plate, the first electrically-controlled viewing angle switching device and the second electrically-controlled viewing angle switching device have a privacy protection axial direction, the second absorption axis has an included angle β2 with respect to the privacy protection axial direction, a third alignment direction of the third alignment layer has an included angle α3 with respect to the privacy protection axial direction, two included angles of a first optical axis of the first quarter-wave plate and a second optical axis of the second quarter-wave plate with respect to the privacy protection axial direction are respectively β2+45 degrees and α3−45 degrees or β2−45 degrees and α3+45 degrees.

21. The display apparatus of claim 19, wherein the display apparatus further comprises a fourth polarizer, and the fourth polarizer is disposed between the second quarter-wave plate and the third alignment layer, wherein the second polarizer is disposed between the second alignment layer and the first quarter-wave plate, the first electrically-controlled viewing angle switching device and the second electrically-controlled viewing angle switching device have a privacy protection axial direction, the second absorption axis has an included angle β2 with respect to the privacy protection axial direction, a fourth absorption axis of the fourth polarizer has an included angle β4 with respect to the privacy protection axial direction, and two included angles of a first optical axis of the first quarter-wave plate and a second optical axis of the second quarter-wave plate with respect to the privacy protection axial direction are respectively β2+45 degrees and β4−45 degrees or β2−45 degrees and β4+45 degrees.

22. The display apparatus of claim 1, wherein the display apparatus further comprises a first compensation film and a second compensation film,
wherein the first compensation film is disposed between the first polarizer and the first electrically-controlled viewing angle switching device,
the second compensation film is disposed between the second polarizer and the second alignment layer, between the second polarizer and the third alignment layer, or between the third polarizer and the fourth alignment layer, wherein an out-of-plane phase retardation of each of the first compensation film and the second compensation film is in a range of −50 nm to-300 nm or in a range of 100 nm to 500 nm.
